(19) United States
(12) Patent Application Publication
(10) Pub. No.: US 2006/0128241 A1
(43) Pub. Date: Jun. 15, 2006

(54) Thermal-responsive textile product

(75) Inventor: Sheng-Mao Tseng, Taipei City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Taiwan Textile Research Institute, Tucheng City (TW)

(21) Appl. No.: 11/203,893

(22) Filed: Aug. 15, 2005

(30) Foreign Application Priority Data
Dec. 15, 2004 (TW) 093139031

(51) Int. Cl. B32B 5/02; B32B 27/34; B32B 27/04; B32B 9/04; B32B 27/12

(52) U.S. Cl. 442/85; 442/59; 442/86; 442/158

(57) ABSTRACT

The invention provides a thermal-responsive moisture permeable and waterproof textile product. The moisture-permeable and waterproof product contains a textile substrate of textile product and a moisture-permeable and waterproof layer, which is coated on at least one side, and the moisture-permeable and waterproof layer contains a polymer and a thermoshrinking volume phase transition substance.

### FIELD OF THE INVENTION

The invention relates to a moisture-permeable and waterproof textile product, more particularly to a moisture-permeable and waterproof textile product with thermal-responsive feature.

### BACKGROUND OF THE INVENTION

The materials capable of varying their properties with the environmental stimulation are called intelligent materials. Currently, the intelligent thermal-responsive materials are widely used in drug delivery field and for organic biomaterials. Typically, the thermal-responsive polymers are classified as three types in accordance with their volume phase transition behavior, namely thermoswelling polymer, thermoshrinking polymer and convexo. The thermoswelling polymer is characterized in the intrinsic volume expansion occurred when the temperature is on the rise while the volume of the thermoshrinking polymer would contract when the temperature is on the rise. Moreover, depending on the environmental condition, the volume of the convexo would expand or contract correspondingly.

The thermoswelling polymer is primarily formed from the hydrophilic monomers, such as the polymer formed from the polymerization of acrylamide, methacrylate or acrylate. The thermoshrinking polymer mainly includes the polymer of N-substituted acrylamide monomer containing the hydrophobic group, such as the polymer formed from the polymerization of N-methylacrylamide, N,N-dimethylacrylamide or N-isopropylacrylamide. The thermoshrinking polymer will demonstrate a low critical selection temperature (LCST) behavior while being dissolved in a water solution. The so-called LCST behavior means that the hydrogen bond existing between the polymer molecule and water molecule is obviously strong so that the polymer molecules are stretched and swelled by water molecules in the water solution when the temperature is below the LCST. However, when the temperature rises above the LCST, the intermolecular force of the polymer molecules becomes significantly larger than that of the hydrogen bond between the polymer molecule and the water molecule, so as to make the polymer demonstrate apparent hydrophobic characteristics. Because of the phase separation of the polymer molecule from the water molecule arising from the molecular chain shrinking in the water solution, the volume contraction phenomenon of the polymer may hence take place.

As for a typical moisture-permeable and waterproof textile product, the moisture-permeable and the waterproof properties come from the characteristics of the physical structure and the chemical composition of the coating on the product or the layer thereon. A composition with high hydrophilicity for the coating is disclosed in the U.S. Pat. No. 5,049,638, wherein the polyethylene oxide glycol (PEG) is mixed with other compound capable of providing active hydrogen, and polymized with a polyisocyanates to form a paint solution or dispersion which is further applied on a substrate so as to fabricate a moisture-permeable and waterproof product. The water vapor permeability of such moisture-permeable and waterproof product is up to 7,000 g/m²*24 Hr. Besides, a moisture-permeable and waterproof film formed by a segmented polyurethane is also disclosed in U.S. Pat. No. 5,120,813. Such a segmented polyurethane contains at least one hard segment and at least one soft segment containing hydrophilic mixtures and hydrophobic mixtures, wherein the hard segment is composed of diisocyanate and monomer glycol or diamine and the soft segment is composed of hydrophilic polyols and hydrophobic polyols. The hydrophilic ployols may a copolymer glycol formed from the ring-opening polymerization of ethylene oxide and propylene oxide and the hydrophobic polyols may contain polysiloxane glycol, polyester glycol or polyalkoxy glycol. The moisture permeability of the moisture-permeable and waterproof film is also up to 7000 g/m²*24 Hr or even more. Furthermore, a porous moisture permeable and waterproof product is provided in the U.S. Pat. No. 5,204,403, which relates to a porous coating containing the polyurethane resin and inorganic particles with mean diameter of less than 0.1 micrometer. The thicknesswise oriented fine pores of the porous coating have an honeycomb skin core structure of 1 to 20 micrometer in diameter and the water vapor permeability is up to 6,000 g/m*24 Hr or even more.

Although the mentioned moisture-permeable and waterproof films achieve substantial moisture permeable and waterproofing effects in a regular manner, these three films lack of flexibility in adjusting their structures to enhance the water vapor permeability for evacuating a great amount of moisture inevitably result from an apparent temperature variation in the surrounding.

Based on the above, in order to overcome the drawbacks in the prior art, the present invention provides an improved moisture-permeable and waterproof textile product with the thermal-responsive feature, which obviously enhances the water vapor permeability of the textile product when the textile product is positioned at a temperature above the LCST of the thermoshrinking volume phase transition substance.

### SUMMARY OF THE INVENTION

In accordance with a first aspect of the present invention, a moisture-permeable and waterproof textile product is provided. The provided textile product with a temperature sensitivity contains a textile substrate, a moisture-permeable and waterproof layer, having a polymer and a thermoshrinking volume phase transition substance.

Preferably, the thermoshrinking volume phase transition substance is a gel of a thermoshrinking volume phase transition polymer.

Preferably, a low critical solution temperature (LCST) of the particle of the thermoshrinking volume phase transition polymer is ranged from 10° C. to 50° C.

Preferably, the LCST of the particle of the thermoshrinking polymer is ranged from 15° C. to 35° C.

Preferably, the particle of the thermoshrinking volume phase transition polymer contains at least one of an N-substituted acrylamide and an N, N-substituted acrylamide.

Preferably, the N-substituted acrylamide is an N-isopropylacrylamide (NIPAAm).

Preferably, the N,N-substituted acrylamide is an N,N-dimethylacrylamide.

Preferably, the textile product has the thermoshrinking volume phase transition substance is in a range from 0% to 40% by weight of the textile product.

Preferably, the textile product has the particle of the thermoshrinking volume phase transition polymer in a range from 0% to 20% by weight of the textile product.

Preferably, the thermoshrinking volume phase transition substance is a thermoshrinking volume phase transition oligomer.

Preferably, an LCST of the thermoshrinking volume phase transition oligomer is ranged from 10° C. to 50° C.

Preferably, the LCST of the thermoshrinking volume phase transition oligmer is ranged from 15° C. to 35° C.

Preferably, the thermoshrinking volume phase transition oligomer contains at least one of an N-substituted acrylamide and an N,N-substituted acrylamide.

Preferably, the thermoshrinking volume phase transition substance has an oligomer being one of an N-substituted acrylamide and an N,N-substituted acrylamide.

Preferably, the N-substituted acrylamide is an N-isopropylacrylamide.

Preferably, the N,N-substituted acrylamide is an N,N-dimethylacrylamide.

Perferably, the textile product has the thermoshrinking volume phase transition oligomer in a range from 0% to 40% by weight of the textile product.

Preferably, the textile product has the thermoshrinking volume phase transition oligomer in a range from 0% to 20% by weight of the textile product.

Preferably, the polymer is a polyurenthane resin.

Preferably, the polymer is a polyamide resin.

Preferably, the polymer is a polyester resin.

Preferably, the polymer is a poly(alkyl) acrylate (ester) resin.

In accordance with a second aspect of the present invention, a moisture-permeable and waterproof layer with thermal responsive feature is provided. The provided layer contains a gel of thermoshrinking volume phase transition polymer and a polymer.

Preferably, the gel of the thermoshrinking volume phase transition polymer has at least one of an N-substituted acrylamide, an N,N-substituted acrylamide, and a cross-linking agent.

Preferably, the N-substituted acrylamide is an N-isopropylacrylamide (NIPAAm).

Preferably, the N,N-substituted acrylamide is an N,N-dimethyl acrylamide.

Preferably, the cross-linking agent is one selected from a group consisting of compounds containing two double bonds, three double bonds or more double bonds.

Preferably, the cross-linking agent with two double bonds is one selected from a group consisting of a methylene bis(acrylamide) (MBA), an ethylene glycol diacrylate, an ethylene glycol diacrylamide and an 1,6-(hexanediol) diacrylate.

Preferably, the cross-linking agent with three double bonds is one selected from a group consisting of a trimethylolpropane triacrylate, a pentaerythritol triacrylate and a melamine trimethacrylamide or melamine triacrylamide.

Preferably, the cross-linking agent with more double bonds is a pentaerythritol tetraacrylate.

Preferably, the particle of the thermal-contration volume phase transition polymer is in a range from 0% to 40% by weight of the layer.

Preferably, the particle of the thermoshrinking volume phase transition polymer is in a range from 0% to 20% by weight of the layer.

Preferably, the layer contains a pigment in a range from 0% to 5% by weight of the layer.

Preferably, the layer contains a polyurethane as the cross-linking agent in a range from 0% to 3% by weight of the layer.

Preferably, the polymer is a polyurenthane resin.

Preferably, the polymer is a polyamide resin.

Preferably, the polymer is a polyester resin.

Preferably, the polymer is a poly(alkyl) acrylate(ester) resin.

Preferably, the layer contains a surfactant.

Preferably, the surfactant has a polyvinyl alcohol (PVAL) and a sodium chloride.

In accordance with a third aspect of the present invention, a thermal-responsive, moisture-permeable and waterproof layer is provided. The layer contains a thermoshrinking volume phase transition oligomer and a polymer.

Preferably, the thermoshrinking volume phase transition oligomer has at least one of an N-substituted acrylamide and an N,N-substituted acrylamide.

Preferably, the N-substituted acrylamide is an N-isopropylacrylamide.

Preferably, the N,N-substituted acrylamide is an N,N-dimethyl acrylamide.

Preferably, the thermoshrinking volume phase transition oligomer is in a range from 0% to 40% by weight of the layer.

Preferably, the thermoshrinking volume phase transition oligomer is in a range from 0% to 20% by weight of the layer.

Preferably, the layer contains a pigment in range from 0% to 5% by weight of the layer.

Preferably, the layer contains a polyurethane as the cross-linking agent in a range from 0% to 3% by weight of the layer.

Preferably, the polymer is a polyurenthane resin.

Preferably, the polymer is a polyamide resin.

Preferably, the polymer is a polyester resin.

Preferably, the polymer is a poly(alkyl) acrylate (ester) resin.

The foregoing and other features and advantages of the present invention will be more clearly understood through the following descriptions with reference to the drawing, wherein:

### BRIEF DESCRIPTION OF THE DRAWINGS

FIG. 1 is a diagram tabularly showing the compositions of the thermoshrinking volume phase transition polymer gels;

FIG. 2 is a diagram tabularly showing the water vapor permeability of the moisture-permeable and waterproof products containing the mixture of the polyurethane resin and the thermoshrinking volume phase transition polymer particles;

FIG. 3 is a diagram showing the relationship between the relative water vapor permeability increment and the temperature of the moisture-permeable and waterproof textile products containing the mixture of the polyurethane resin and thermoshrinking volume phase transition polymer particles;

FIG. 4 is a diagram tabularly showing the water vapor permeability of the moisture-permeable and waterproof textile products containing the copolymer of the polyurethane resin and thermoshrinking volume phase transition oligomer; and

FIG. 5 is the diagram showing the relationship of the moisture-permeable and waterproof textile products containing the copolymer of the polyurethane resin and thermoshrinking volume phase transition oligomer.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

Preparation of the moisture-permeable and waterproof textile product with thermoshrinking volume phase transition polymer and polymer blend of polyurethane includes the following steps:

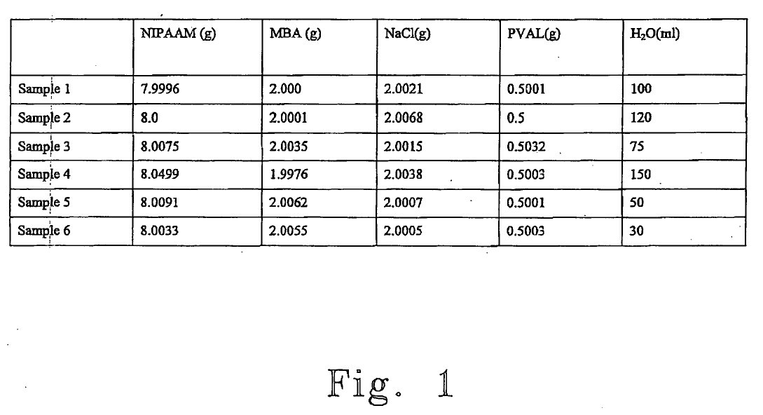

Please refer to FIG. 1, which is a diagram tabularly showing the compositions of the thermoshrinking volume phase transition polymer particles. In accordance with the compositions shown in FIG. 1, the polyvinyl alcohol (PVAI), the sodium chloride, the N-isopropylacrylamide, the methylene bis(acrylamide) (MBA) are sequentially and stoichiometrically added in a 4-neck reactor for being dissolved in the deionized water therein. The dissolved chemicals are provided with a nitrogen atmosphere, so as to react and to be purificated therein. The reaction lasts for 4-6 hours and the reaction temperature is ranged from 50° C. to 70° C. The white solid powders obtained therefrom are exactly the gels of the thermoshrinking volume phase transition polymer.

Furthermore, the particles of the thermoshrinking volume phase transition polymer are mixed with the moisture-permeable and waterproof polyurethane resin. The amount of the particles of the thermoshrinking volume phase transition polymer is ranged from 0% to 40% by weight of the mixture and preferably, is ranged from 0% to 20% or from 0% to 10% by weight of the mixture. After being evenly blended, a pigment having an amount ranged from 0% to 5% by weight of the mixture, and/or a polyurethane cross linking agent in a range of 0% to 3%, by weight of the mixture are added in sequence so as to form a uniform paint, whose viscosity is approximately 8500 cps at 25° C. The obtained paint is applied on the cloth of nylon or polyester and dried respectively the cloth at 100° C. and 160° C. for 1 minute. The moisture-permeable and waterproof textile product with a coating amount ranged from 20 to 40 g/m² is produced.

Preparation of the moisture-permeable and waterproof textile product with thermoshrinking volume phase transition oligomer and polyurethane copolymer includes the following steps:

A two-stage polymerization is involved in the preparation. Firstly, the N-isopropylacrylamide oligomer having active hydrogen is synthesized. The synthesized oligomer having an amount ranged from 0% to 40% by the mixture is mixed with the polyurethane prepolymer. Preferably, the amount of the oligomer is ranged from 0% to 20%, or evenly ranged from 0% to 10% by weight of the mixture. Secondly, the mixture of the N-isopropylacrylamide oligomer and the polyurenthane prepolymer are chain-elongated and water-converted at the room temperature, and a dispersion containing the thermoshrinking volume phase transition oligomer and polyurethane copolymer is derived therefrom. Lastly, a pigment having an amount ranged from 0% to 5% by weight of the dispersion, and/or a polyurethane cross-linking agent having an amount ranged from 0% to 3% by weight of the dispersion are added into the dispersion in sequence to form a uniform paint. The obtained paint is applied on the cloth of nylon or polyester and respectively dried at 100° C. and 160° C. for 1 minute. The moisture-permeable and waterproof textile product with a coating amount ranged from 20 to 40 g/m² is produced.

Measurement of Moisture Vapor Transmission Rate (MVTR):

The mentioned moisture-permeable and waterproof textile product is tested by means of the water-pouring method, and the testing procedure thereof is specified in ASTM standards from ANSI, i.e. ASTM E96, in American National Standard Institute, in which the coated surface of the sample is submerged by the deionized water at the humidity of 50% RH and the moisture vapor transmission rate (MVTR) of the sample tested at different temperature are calculated as follows:
MVTR=(Δw)*(24 Hr)/(t*A),
wherein “Δw” is the weight variation amount (g) of the sample, “t” is the measurement time (hour) and “A” is the area of the sample (m²).

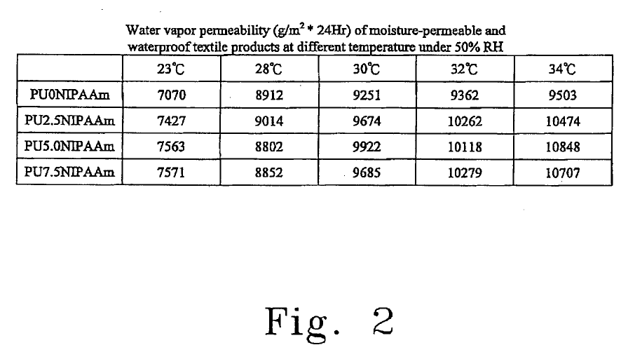

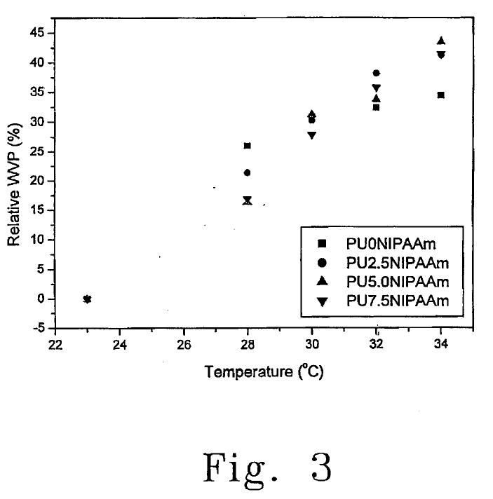

Please refer to FIG. 2 and FIG. 3, wherein FIG. 2 is a diagram tabularly showing the water vapor permeability rate of the moisture-permeable and waterproof textile product with the thermoshrinking volume phase transition polymer and polymer blend of ployrurethane and FIG. 3 is a diagram showing the relationship between the relative water vapor permeability increments and the temperature of the moisture-permeable and waterproof textile products containing the mixture of the polyurethane resin and thermoshrinking volume phase transition polymer particles, in which the relative water vapor permeability increment (relative MVTR) is defined by the difference between the water vapor permeability at a specific temperature, i.e. 28° C., 30° C., 32° C. and 34° C., and the water vapor permeability at a reference temperature, i.e. 23° C. As shown in FIG. 3, the relative moisture vapor transmission rate (MVTR) increment of the moisture-permeable and waterproof textile product containing the thermoshrinking volume phase transition polymer is less than that of the pure polyurethane resin when the temperature is below 32° C., and to the contrary the relative water vapor permeability increment of the moisture-permeable and waterproof textile product is apparently more than that of the pure polyurethane resin when the temperature is above 32° C.

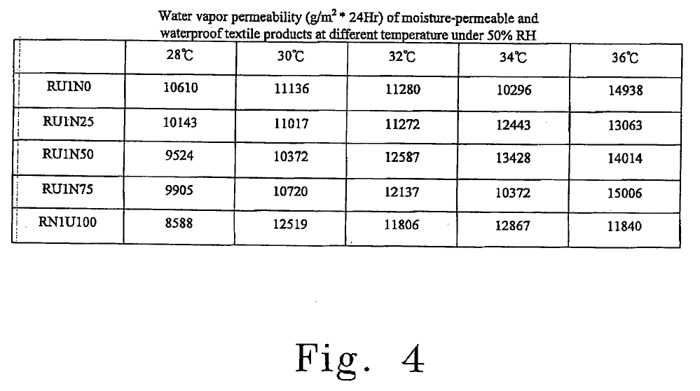

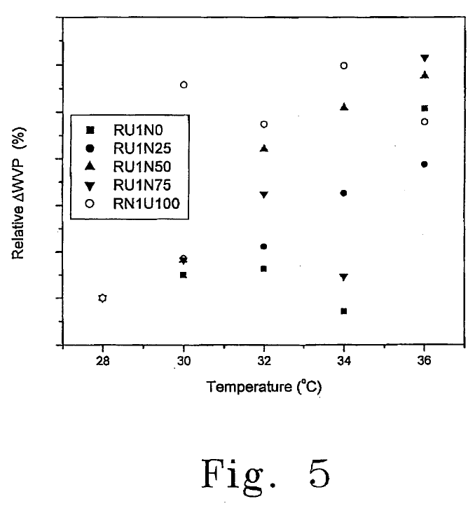

Please refer to FIG. 4 and FIG. 5, wherein FIG. 4 is a diagram tabularly showing the water vapor permeability rate of moisture-permeable and waterproof textile product with the copolymer of the polyurethane resin and thermoshrinking volume phase transition oligomer and FIG. 5 is a diagram showing the relationship between the relative water vapor permeability increments and the temperature of the moisture-permeable and waterproof textile products containing the copolymer of the polyurethane resin and thermoshrinking volume phase transition oligomer. As shown in FIG. 5, the relative water vapor permeability increment of the moisture-permeable and waterproof textile product containing the thermal-ocntraction volume phase transition and copolymer (i.e. the copolymer having N-isopropylarcrylamide) is higher than that of the pure polyurethane when the temperature is above 30˜32 ° C. Furthermore, the relative water vapor permeability increment of the moisture-permeable and waterproof textile product containing the thermoshrinking volume phase transition oligomer and the copolymer is even up to 50% at 34° C. when the contents of the thermoshrinking volume phase transition oligomer is 10%.

In summary, due to the fact that the invention provides a moisture-permeable and waterproof textile product, which is capable of adapting to the temperature of the surrounding environment and whose water vapor permeability property is enhanced by replacing the conventional pure moisture-permeable and waterproof base material coated on textile product with the moisture-permeable and waterproof layer containing thermoshrinking volume phase transition substance, the present invention is innovative, progressive and practical.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A thermal-responsive textile product, comprising:
a textile substrate; and
a moisture-permeable and waterproof layer, having a polymer and a thermoshrinking volume phase transition substance.

2. The textile product of claim 1, wherein said thermoshrinking volume phase transition substance is a gel of a thermoshrinking volume phase transition polymer.

3. The textile product of claim 2, wherein a low critical solution temperature (LCST) of said gel of said thermoshrinking volume phase transition polymer is ranged from 10° C. to 50° C.

4. The textile product of claim 2, wherein a low critical solution temperature (LCST) of said gel of said thermoshrinking polymer is ranged from 15° C. to 35° C.

5. The textile product of claim 2, wherein said gel of said thermoshrinking volume phase transition polymer comprises at least one of an N-substituted acrylamide and an N,N-substituted acrylamide.

6. The textile product of claim 5, wherein said N-substituted acrylamide is an N-isopropylacrylamide.

7. The textile product of claim 5, wherein said N,N-substituted acrylamide is an N,N-dimethyl acrylamide.

8. The textile product of claim 2 having said thermoshrinking volume phase transition substance in a range from 0% to 40% by weight of said textile product.

9. The textile product of claim 2 having said gel of said thermoshrinking volume phase transition polymer in a range from 0% to 20% by weight of said textile product.

10. The textile product of claim 1, wherein said thermoshrinking volume phase transition substance is a thermoshrinking volume phase transition oligomer.

11. The textile product of claim 10, wherein a low critical solution temperature (LCST) of said thermoshrinking volume phase transition oligomer is ranged from 10° C. to 50° C.

12. The textile product of claim 10, wherein a low critical solution temperature (LCST) of said thermoshrinking volume phase transition oligmer is ranged from 15° C. to 35° C.

13. The textile product of claim 10, wherein said thermoshrinking volume phase transition substance has an oligomer being one of an N-substitued acrylamide and an N,N-substituted acrylamide.

14. The textile product of claim 13, wherein said N-substituted acrylamide is an N-is opropylacrylamide.

15. The textile product of claim 13, wherein said N,N-substituted acrylamide is an N,N-dimethyl acrylamide.

16. The textile product of claim 10 having said thermoshrinking volume phase transition oligomer in a range from 0% to 40% by weight of said textile product.

17. The textile product of claim 10 having said thermoshrinking volume phase transition oligomer in a range from 0% to 20% by weight of said textile product.

18. The textile product of claim 1, wherein said polymer is a polyurenthane resin.

19. The textile product of claim 1, wherein said polymer is a polyamide resin.

20. The textile product of claim 1, wherein said polymer is a polyester resin.

21. The textile product of claim 1, wherein said polymer is a poly(alkyl) acrylate (ester) resin.

22. A thermal-responsive moisture-permeable and waterproof layer comprising:
a gel of thermoshrinking volume phase transition polymer; and
a polymer.

23. The layer of claim 22, wherein said gel of thermoshrinking volume phase transition has at least one of an N-substituted acrylamide, an N,N-substituted acrylamide and a cross-linking agent.

24. The layer of claim 23, wherein said N-substituted acrylamide is an N-isopropylacrylamide.

25. The layer of claim 23, wherein said N,N-substituted acrylamide is an N,N-dimethyl acrylamide.

26. The layer of claim 23, wherein said cross-linking agent is one selected from a group consisting of compounds containing two double bonds, three double bonds or more double bonds.

27. The layer of claim 23, wherein said cross-linking agent with two double bonds is one selected from a group consisting of a methylene bis(acrylamide) (MBA), an ethylene glycol diacrylate, an ethylene glycol diacrylamide and an 1,6-(hexanediol) diacrylate.

28. The layer of claim 23, wherein said cross-linking agent with three double bonds is one selected from a group consisting of a trimethylolpropane triacrylate, a pentaerythritol triacrylate and a melamine trimethacrylamide or melamine triacrylamide.

29. The layer of claim 23, wherein said cross-linking agent with more double bonds is a pentaerythritol tetraacrylate.

30. The layer of claim 22, wherein said gel of said thermoshrinking volume phase transition polymer is in a range from 0% to 40% by weight of said layer.

31. The layer of claim 22, wherein said particle of said thermoshrinking volume phase transition polymer is in a range from 0% to 20% by weight of said layer.

32. The layer of claim 22, comprising a pigment in a range from 0% to 5% by weight of said layer.

33. The layer of claim 22, comprising a polyurethane as said cross-linking agent in a range from 0 to 3% by weight of said layer.

34. The layer of claim 22, wherein said polymer is a polyurenthane resin.

35. The layer of claim 22, wherein said polymer is a polyamide resin.

36. The layer of claim 22, wherein said polymer is a polyester resin.

37. The layer of claim 22, wherein said polymer is a poly(alkyl) acrylate acid (ester) resin.

38. The layer of claim 22, comprising a surfactant.

39. The layer of claim 38, wherein said surfactant has a polyvinyl alcohol (PVAl) and a sodium chloride.

40. A thermal-responsive, moisture-premeable and waterproof layer, comprising:
a thermoshrinking volume phase transition oligomer; and
a polymer.

41. The layer of claim 40, wherein said thermoshrinking volume phase transition oligomer has at least one of an N-substituted acrylamide and an N,N-substituted acrylamide.

42. The layer of claim 41, wherein said N-substituted acrylamide is an N-isopropylacrylamide.

43. The layer of claim 41, wherein said N,N-substituted acrylamide is an N,N-dimethyl acrylamide.

44. The layer of claim 40, wherein said thermoshrinking volume phase transition oligomer is in a range from 0% to 40% by weight of said layer.

45. The layer of claim 40, wherein said thermoshrinking volume phase transition oligomer is in a range from 0% to 20% by weight of said layer.

46. The layer of claim 40, comprising a pigment in a range from 0% to 5% by weight of said layer.

47. The layer of claim 40, comprising a polyurethane as said cross-linking agent in a range from 0% to 3% by weight of said layer.

48. The layer of claim 40, wherein said polymer is a polyurenthane resin.

49. The layer of claim 40, wherein said polymer is a polyamide resin.

50. The layer of claim 40, wherein said polymer is a polyester resin.

51. The layer of claim 40, wherein said polymer is a poly(alkyl) acrylate (ester) resin.
